(19) United States
(12) Patent Application Publication
(10) Pub. No.: US 2026/0084041 A1
(43) Pub. Date: Mar. 26, 2026

(54) CAMERA SYSTEM FOR ICE HOCKEY RINK AND METHOD OF OPERATION

(71) Applicants: Jonathan R. Fish, Fairfield, CT (US); Joan Taylor Fish, Fairfield, CT (US); Bradley C. Fish, Fairfield, CT (US)

(72) Inventors: Jonathan R. Fish, Fairfield, CT (US); Joan Taylor Fish, Fairfield, CT (US); Bradley C. Fish, Fairfield, CT (US)

(21) Appl. No.: 19/112,550

(22) PCT Filed: Jul. 30, 2024
(86) PCT No.: PCT/US2024/040204

§ 371 Date: Mar. 17, 2025

Related U.S. Application Data
(60) Provisional application No. 63/529,867, filed on Jul. 31, 2023.

(51) Int. Cl. A63C 19/10; A63B 69/00; G03B 17/56; G03B 29/00; H04N 23/57; H04N 23/66; H04N 23/68; H04N 23/695

(52) U.S. Cl. CPC A63C 19/10; A63B 69/0026; G03B 17/561; G03B 29/00; H04N 23/57; H04N 23/66; H04N 23/685; H04N 23/695; A63B 2220/806; A63B 2225/50; A63C 2203/24

(57) ABSTRACT

According to one aspect of the disclosure, a camera system for a hockey rink is provided. The system includes a rink wall defining a hollow interior, the rink wall having a window portion on a rink side of the rink wall. A rail is disposed within the hollow interior. A camera is operably coupled to the rail within the hollow interior and having a lens with an optical axis extending through the window portion. A movement device is operably coupled to the camera and configured to move the camera along the rail.

### CROSS-REFERENCE TO RELATED APPLICATIONS

The present application claims priority to United States Provisional Application Serial No. 63/529867 entitled CAMERA SYSTEM FOR ICE HOCKEY RINK AND METHOD OF OPERATION filed Jul. 31, 2023, the contents of which is incorporated by reference herein.

### BACKGROUND OF THE DISCLOSURE

The subject matter disclosed herein relates to a camera system, and particular to a camera system for recording video within a hockey rink during a game, before/after a game, or during a practice session.

Hockey is a popular sport throughout the world. To enable more viewers to enjoy the sport, games are televised allowing viewers to watch the game from home. Since hockey is a fast paced sport, television broadcasters often need to use camera placements that allow for a large field of view to avoid having the puck or players of interest move out of the television image. Further, to avoid blocking the view of spectators at the game, the television cameras are located in fixed positions. As a result, it is often not possible for the television spectator to have a desired view of the game.

While existing camera systems are suitable for their intended purposes the need for improvement remains, particularly in providing a camera system having the features described herein.

### BRIEF DESCRIPTION OF THE DISCLOSURE

According to one aspect of the disclosure, a camera system for a hockey rink is provided. The system includes a rink wall defining a hollow interior, the rink wall having a window portion on a rink side of the rink wall. A rail is disposed within the hollow interior. A camera is operably coupled to the rail within the hollow interior and having a lens with an optical axis extending through the window portion. A movement device is operably coupled to the camera and configured to move the camera along the rail.

In addition to one or more of the features described herein, or as an alternative, further embodiments of the camera system may include the rink wall having a back panel on a side opposite the window portion, the back panel being selectively removable from the rink wall and positioned to allow access to the camera and rail when removed.

In addition to one or more of the features described herein, or as an alternative, further embodiments of the camera system may include the window extending a length of the wall.

In addition to one or more of the features described herein, or as an alternative, further embodiments of the camera system may include the window extending in a direction that is perpendicular to a surface of the hockey rink.

In addition to one or more of the features described herein, or as an alternative, further embodiments of the camera system may include the window being seemless with an interior surface of the rink wall.

In addition to one or more of the features described herein, or as an alternative, further embodiments of the camera system may include the window being made from a translucent or frosted glass.

In addition to one or more of the features described herein, or as an alternative, further embodiments of the camera system may include a frame member at least partially disposed within the hollow interior between the rail and the camera.

In addition to one or more of the features described herein, or as an alternative, further embodiments of the camera system may include the optical axis being 12-18 inches (30.5-45.7 centimeters) above a surface of ice in the hockey rink.

In addition to one or more of the features described herein, or as an alternative, further embodiments of the camera system may include a gimbal mechanism coupled between the camera and the rail, the gimbal mechanism is configured to provide image stabilization during movement.

In addition to one or more of the features described herein, or as an alternative, further embodiments of the camera system may include the optical axis being perpendicular to the window.

In addition to one or more of the features described herein, or as an alternative, further embodiments of the camera system may include the optical axis being on an angle relative to a surface normal of the window.

In addition to one or more of the features described herein, or as an alternative, further embodiments of the camera system may include a tilting and/or rotation mechanism disposed between the camera and the rail, the tilting and/or rotation mechanism being configured to change the angle of the optical axis relative to a surface normal of the window.

According to another aspect of the disclosure, a camera system for a hockey rink is provided. The camera system includes a rink wall defining a hollow interior, the rink wall having a window portion on a rink side of the rink wall. A rail is disposed within the hollow interior. The rail may be comprised of two members (dual tracks) or a single member (monorail). A camera is operably coupled to the rail within the hollow interior and having a lens with an optical axis extending through the window portion. A movement device is operably coupled to the camera and configured to move the camera along the rail. A controller is electrically coupled to the camera and the movement device, the controller being configured to acquire images with the camera in response to a first input from a user and move the camera long the rail with the movement device in response to a second input from the user.

In addition to one or more of the features described herein, or as an alternative, further embodiments of the camera system may include a power supply electrically coupled to the camera and the movement device.

In addition to one or more of the features described herein, or as an alternative, further embodiments of the camera system may include the power supply being a battery.

In addition to one or more of the features described herein, or as an alternative, further embodiments of the camera system may include the controller being coupled for communication to the camera via a wireless connection.

In addition to one or more of the features described herein, or as an alternative, further embodiments of the camera system may include the controller being coupled for communication to the camera via a wired connection.

According to yet another aspect of the disclosure a method is provided. The method include acquiring images with a camera, the camera being movably mounted by a movement device to a rail within a wall of an hockey rink, the camera being positioned to acquire images through a window in the wall. The camera is moved along the rail with the movement device while acquiring images.

In addition to one or more of the features described herein, or as an alternative, further embodiments of the camera system may include the images being a video image.

In addition to one or more of the features described herein, or as an alternative, further embodiments of the camera system may include the moving of the camera comprising moving the camera under at least one of a team bench, a penalty box, or a Zamboni entrance.

In addition to one or more of the features described herein, or as an alternative, further embodiments of the camera system may include the acquiring of the images comprises selectively acquiring the images in response to a first input from an operator. In addition to one or more of the features described herein, or as an alternative, further embodiments of the camera system may include the moving of the camera along the rail comprising a selective movement in response to a second input from an operator.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a wall/boards portion of a hockey rink having an integral camera system in accordance with an embodiment;

FIG. 2 is a sectional view of the wall portion of FIG. 1 in accordance with an embodiment;

FIG. 3 is a schematic block diagram of a hockey rink video system in accordance with an embodiment; and

FIG. 4 is a plan view of a hockey rink incorporating an integral camera system in accordance with an embodiment.

The detailed description explains embodiments of the disclosure, together with advantages and features, by way of example with reference to the drawings.

### DETAILED DESCRIPTION OF THE DISCLOSURE

Embodiments of the present disclosure provide for camera system incorporated into at least a portion of a wall for a hockey game. Further embodiments of the present disclosure provide for a movable camera system that is integrated/embedded into a wall (including boards or dashers) of a hockey rink for providing video images of the hockey rink and players during a game. Embodiments of the present disclosure provide advantages in allowing the videoing of a hockey game from vantage points not available through traditional video camera placement positions.

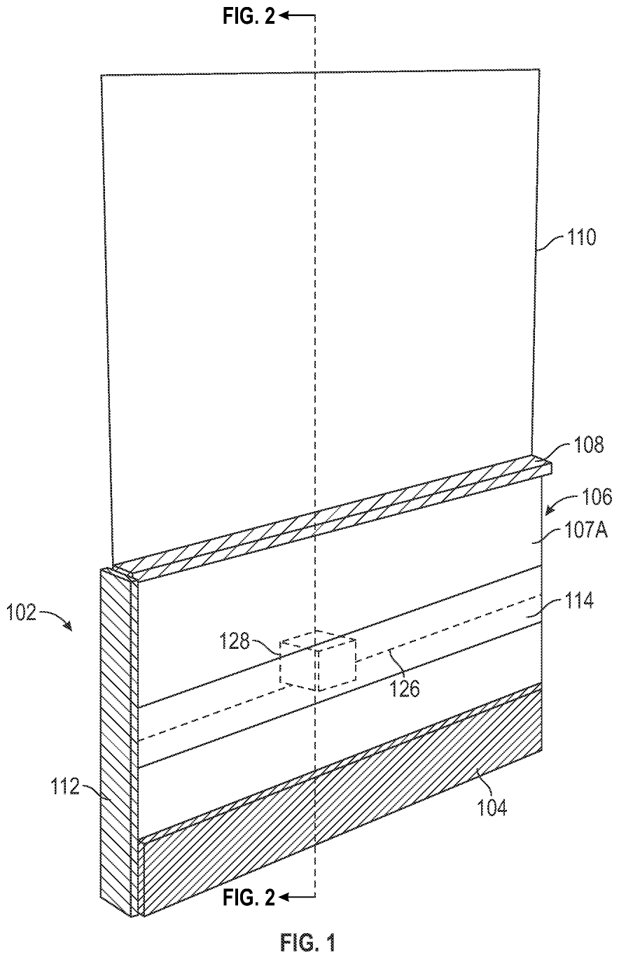

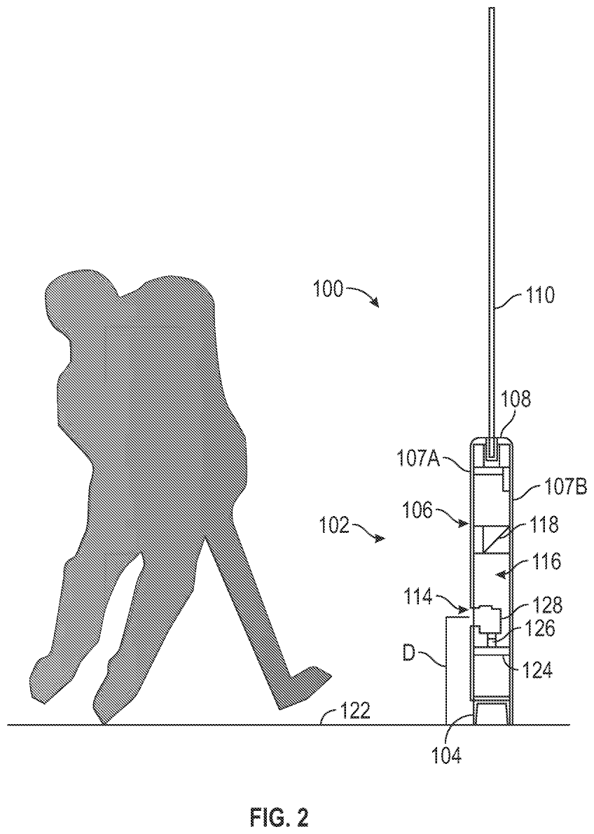

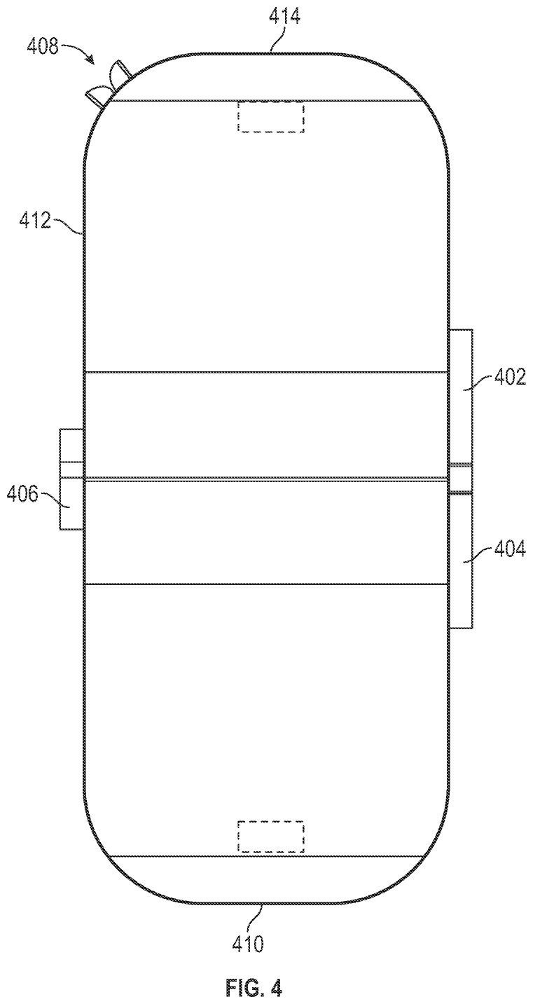

Referring now to FIG. 1 and FIG. 2, an embodiment is shown of a system 100 that includes a wall 102 configured to be incorporated into a hockey rink (e.g. hockey rink 400, FIG. 4). The wall 102 includes a kickplate 104, a framed board 106, a hand rail 108 and transparent shielding 110. In an embodiment, a support 112 (sometimes referred to as a grounded support strut) may be coupled to an end of a wall 102 section.

In an embodiment, the framed board 106 includes a window portion 114 that extends along the length of the wall 102 in an orientation generally parallel with the ice surface of the rink. The window portion 114 may be made from a suitable transparent material, such as but not limited to polycarbonate for example. In an embodiment, the window portion 114 is substantially seamless with the adjacent board surfaces to as not interfere or change the trajectory of the puck when it contacts the wall 102. The framed board 106 includes a first side 107A and a second side 107B that defines a hollow interior 116. In an embodiment, the second side 107B includes a plate (not shown) that may be selectively removed to allow access to the interior of the wall 102 (e.g. to access the rail 124 or camera 128 described herein). The wall 102 may include interior support structure, such as bracket 118 for example, as is known in the art. In an embodiment, a channel or opening may be formed in the support 112 to allow the movement of the camera.

In an embodiment, the wall 102 may further include a frame member 124 positioned a predetermined distance from the surface 122 of the ice rink. In an embodiment, the frame member 102 is configured to be generally parallel with the surface 122. In other embodiments, the frame member 102 may be angled. Coupled to the frame member 126 is a rail 124. In an embodiment, the rail 126 is coupled to a top surface of the frame member 126 (e.g. a surface with a surface normal parallel with the surface normal of the surface 122). In an embodiment, the rail 126 may be coupled free floating to the top surface. In another embodiment, the rail 126 may be coupled to a bottom surface of the frame member 126. In an embodiment, the rail 126 may be comprised of a pair of parallel members/tracks. In another embodiment, the rail 126 may be a single member/track or monorail configuration.

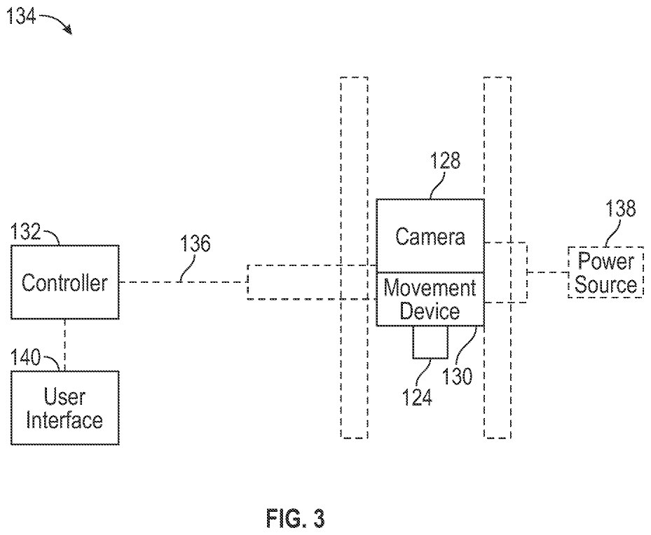

The rail or rails 126 is configured to support and guide a movable camera 128. In an embodiment, the camera 128 is operably coupled to a movement device 130 (FIG. 3). The movement device 130 may be any suitable device configured to selectively move the camera 128 along the rail 126, such as but not limited to a motorized wheel or a cable/pulley arrangement for example. The camera head 128 itself may be attached to a gimbal device to add movement and stability to the acquired images during operation. In an embodiment, the rail 126 may be configured to transfer one or more of electrical power, computer signals, radio frequencies, or video signals between the camera, the movement device, and a remote controller 132.

The camera 128 includes a lens assembly having an optical axis that extends through the window 114 into the hockey rink. In an embodiment, the optical axis or center of the lens is positioned a predetermined distance D above the surface 122. It should be appreciated that this allows for the capturing of video during a hockey game. In an embodiment, the distance D is 18 inches (45.7 centimeters) above the surface 122. In another embodiment, the distance D is selected to position the optical axis of the lens assembly at about the waist height of the players. In an embodiment, the optical axis is perpendicular to the window (e.g. parallel to a surface normal of the window). In another embodiment, the optical axis is on an angle relative to the window (e.g. on an angle relative to a surface normal of the window). In an embodiment, the window 114 may be transparent or translucent. In another embodiment, the window may be completely or at least partially frosted (e.g. a center portion/strip that is transparent with the edges frosted).

It should be appreciated that while the embodiment of FIG. 1 and FIG. 2 illustrate a single rail/camera assembly within the wall 102, this is for example purposes and the claims should not be so limited. In other embodiments, multiple rail/camera assemblies may be positioned within the hollow interior 116. Further, while embodiments herein may refer to the rail 126 as guiding the camera 128 along a plane parallel with the surface 122, in other embodiments, the rail 126 may be angled or curved to provide different video angles in different parts of the ice rink. Further still, in other embodiments, the camera 128 may include a gimbal mechanism between the rail 126 and the camera sensor to provide image stabilization during movement. In still further embodiments, the camera 128 may include a tilting and/or rotation mechanism that allows for the selective angling and rotation of the camera relative to the rail 126 (i.e to change the angle of the optical axis of the camera). The tilting and/or rotation mechanism may be disposed between the camera and the rail.

Referring now to FIG. 3, an embodiment of a control system 134 is shown for operating the camera 128. The system 134 includes a controller 132 that is operably coupled to the camera 128 and the movement device 130. The controller 132 may be coupled to the cameras 128 and movement device 130 by any suitable communications medium 136 for transmitting one or more of electrical power, data signals (e.g. control signals), and receiving a stream of video images. The communications medium may be wired, such as using cables for example, wireless, such as a radio frequency protocol (e.g. Bluetooth™, or Wi-Fi) for example, or a combination of the foregoing. The controller 132 may include one or more processors. In an embodiment, the controller 132 may be comprised of a plurality of computing devices/processors that are configured in a distributed network environment.

In an embodiment, the movement device 130 includes an electrical motor that is coupled to move the cameras 128 along the rail 124. In an embodiment, the motor may be coupled to wheels that engage the rail and rotate in response to the motor receiving a signal. In another embodiment, the rail 124 may include features, such as gear teeth for example, that are engaged by elements (e.g. a gear) coupled to the motor. In other embodiments, the movement device may include a cable system that pulls the cameras 128 along the rail 124. In still further embodiments, the movement device 130 may include a chain and sprocket arrangement for moving the cameras 128 along the rail.

A power source 138 is provided that provides electrical power for operation or one or more of the camera 128 or the movement device 130. The power source 138 may be a battery, an electrical cable coupled directly or indirectly to a utility power system, or a combination of the foregoing. In an embodiment, the power source 138 may be operably coupled to the controller 132.

Also coupled to the controller 132 is a user interface 140 that allows the operator to issue commands to the camera and movement device. In an embodiment, the user interface 140 includes a display configured to receive video images from the camera 128. The user interface 140 may be coupled to the controller 132 by a wired connection, a wireless connection, or a combination of the foregoing. In an embodiment, the user interface 140 is remotely located from the controller 132 and the camera 128.

In operation, the operator issues commands to the controller 132 via the user interface 140. These commands may include operational methods for selectively acquiring video images with the camera 128 and selectively moving the camera 128 along the rail 126. It should be appreciated that since the operator can see the video images acquired by the camera 128, during a game in the hockey rink, the operator can move the camera along the rail 126 to maintain a vantage point of interest to the viewers of the hockey game (e.g. keeping the puck in view).

Referring now to FIG. 4 an embodiment of a hockey rink 400 is shown that incorporates an camera system integrated into the rink walls. A hockey rink 400 includes a number of areas, such as but not limited to the team benches 402, 404, a penalty box 406, and a Zamboni entrance 408. As a result, the rink wall may not be continuous or include different wall configurations (e.g. having doors) about the perimeter of the hockey rink 400. In this embodiment, the hockey rink 400 may include three or more separate integrated camera systems 100. In an embodiment, a first integrated camera system 410 extends between the team bench area 404 and the penalty box 406. A second integrated camera system 412 extends between the penalty box 406 and the Zamboni entrance 408. Finally a third integrated camera system 414 extends between the Zamboni entrance 408 and the team bench area 402.

In other embodiments, the hockey rink may be configured with a rail having portions that extend under one or more of the team benches 402, 404, the penalty box 406, and the Zamboni entrance 408.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present disclosure may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A camera system for a hockey rink, the system comprising:
a rink wall defining a hollow interior, the rink wall having a window portion on a rink side of the rink wall;
a rail disposed within the hollow interior;
a camera operably coupled to the rail within the hollow interior and having a lens with an optical axis extending through the window portion; and
a movement device operably coupled to the camera and configured to move the camera along the rail.

2. The camera system of claim 1, wherein the rink wall includes a back panel on a side opposite the window portion, the back panel being selectively removable from the rink wall and positioned to allow access to the camera and rail when removed.

3. The camera system of claim 1, wherein the window extends a length of the wall.

4. The camera system of claim 3, wherein the window extends in a direction that is parallel to a surface of the hockey rink.

5. The camera system of claim 3, wherein the window is seemless with an interior surface of the rink wall.

6. The camera system of claim 1, further comprising a frame member at least partially disposed within the hollow interior between the rail and the camera.

7. The camera system of claim 1, wherein the optical axis is 12-18 inches (30.5-45.7 centimeters) above a surface of ice in the hockey rink.

8. The camera system of claim 1, further comprising a gimbal mechanism coupled between the camera and the rail, the gimbal mechanism is configured to provide image stabilization during movement.

9. The camera system of claim 1, wherein the optical axis is perpendicular to the window.

10. The camera system of claim 1, wherein the optical axis is on an angle relative to a surface normal of the window.

11. The camera system of claim 10, further comprising a tilting and/or rotation mechanism disposed between the camera and the rail, the tilting and/or rotation mechanism being configured to change the angle of the optical axis relative to a surface normal of the window.

12. A camera system for a hockey rink, the system comprising:
a rink wall defining a hollow interior, the rink wall having a window portion on a rink side of the rink wall;
a rail disposed within the hollow interior;
a camera operably coupled to the rail within the hollow interior and having a lens with an optical axis extending through the window portion;
a movement device operably coupled to the camera and configured to move the camera along the rail; and
a controller electrically coupled to the camera and the movement device, the controller being configured to acquire images with the camera in response to a first input from a user and move the camera long the rail with the movement device in response to a second input from the user.

13. The camera system of claim 12, further comprising a power supply electrically coupled to the camera and the movement device.

14. The camera system of claim 13, wherein the power supply is a battery.

15. The camera system of claim 12, wherein the controller is coupled for communication to the camera via a wireless connection.

16. The camera system of claim 12, wherein the controller is coupled for communication to the camera via a wired connection.

17. A method comprising:
acquiring images with a camera, the camera being movably mounted by a movement device to a rail within a wall of an hockey rink, the camera being positioned to acquire images through a window in the wall;
moving the camera along the rail with the movement device while acquiring images.

18. The method of claim 17, wherein the images are a video image.

19. The method of claim 17, wherein the moving of the camera includes moving the camera under at least one of a team bench, a penalty box, or a Zamboni entrance.

20. The method of claim 17, wherein:
the acquiring of the images includes selectively acquiring the images in response to a first input from an operator; and
the moving of the camera along the rail includes selectively moving the camera in response to a second input from an operator.
